(19) United States
(12) Patent Application Publication
(10) Pub. No.: US 2025/0317368 A1
(43) Pub. Date: Oct. 9, 2025

(54) COMPUTING SERVICE IMPLEMENTATION METHOD AND APPARATUS, COMMUNICATION DEVICE, AND READABLE STORAGE MEDIUM

(71) Applicant: VIVO MOBILE COMMUNICATION CO., LTD., Dongguan (CN)

(72) Inventor: Yannan YUAN, Dongguan (CN)

(21) Appl. No.: 19/243,955

(22) Filed: Jun. 20, 2025

Related U.S. Application Data
(63) Continuation of application No. PCT/CN2023/139726, filed on Dec. 19, 2023.

(30) Foreign Application Priority Data
Dec. 22, 2022 (CN) 202211659014.5

(51) Int. Cl. H04L 41/50; H04L 65/1016; H04W 28/08

(52) U.S. Cl. CPC H04L 41/50; H04L 65/1016; H04W 28/0967

(57) ABSTRACT

A computing service implementation method and apparatus, a communication device, and a readable storage medium are disclosed in the field of communication technologies. The computing service implementation method in this application includes: obtaining, by a first node, first information, where the first information includes information of a target service requested by a service request sending node; and determining, by the first node based on the first information and second information, a target service node that provides the target service, where the second information includes at least one of the following: service information and computational load information of a service node.

### CROSS-REFERENCE TO RELATED APPLICATIONS

This application is a bypass continuation application of International Application No. PCT/CN2023/139726, filed on Dec. 19, 2023, which claims the benefit of and priority to Chinese Patent Application No. 202211659014.5, filed on Dec. 22, 2022, both of which are incorporated by reference in their entireties herein.

### TECHNICAL FIELD

This application relates to the field of wireless communication technologies and, more specifically, relates to a computing service implementation method and apparatus, a communication device, and a readable storage medium.

### BACKGROUND

The 5th Generation Mobile Communication Technology (5G) protocol is primarily designed to provide mobile communication transmission services between user equipment and application functions (or application servers), with the goal of meeting quality of service (QOS) requirements. However, it does not take into account service-specific information or computational load information. In contrast, the Internet Engineering Task Force (IETF) frameworks known as Compute First Networking (CFN) or Computing-Aware Networking (CAN) are focused on integrating such information within wired transmission networks. These approaches consider both service information and computational load when routing traffic through a network. When a service flow is initiated, a router or controller can select an optimal service node, also referred to as a service instance, by evaluating the resource availability, status of the service nodes, and routing costs. To maintain service continuity, flow affinity is used to ensure that the same service node consistently handles the service flow.

### BRIEF SUMMARY

Embodiments of this application provide a computing service implementation method and apparatus, a communication device, and a readable storage medium.

According to a first aspect, a computing service implementation method is provided and includes:
obtaining, by a first node, first information, where the first information includes information of a target service requested by a service request sending node; and
determining, by the first node based on the first information and second information, a target service node that provides the target service, where the second information includes at least one of the following: service information and computational load information of a service node.

According to a second aspect, a computing service implementation method is provided and includes:
receiving, by a second node, a service request data packet sent by a service request sending node, where the service request data packet includes first information, and the first information includes information of a target service requested by the service request sending node;
sending, by the second node, the first information to a first node, where the first information is used to determine a target service node that provides the target service;
receiving, by the second node, information of the target service node sent by the first node; and
forwarding, by the second node to the target service node, the service request data packet sent by the service request sending node, and forwarding, to a service response receiving node, a service response data packet sent by the target service node for the service request data packet.

According to a third aspect, a computing service implementation method is provided and includes:
collecting, by a third node, second information of a service node, where the second information includes at least one of the following: service information and computational load information; and
sending, by the third node, the second information to a first node, so that the second information is used to determine a target service node that provides a target service.

According to a fourth aspect, a computing service implementation apparatus is provided and includes:
a first obtaining module, configured to obtain first information, where the first information includes information of a target service requested by a service request sending node; and
a determining module, configured to determine, based on the first information and second information, a target service node that provides the target service, where the second information includes at least one of the following: service information and computational load information of a service node.

According to a fifth aspect, a computing service implementation apparatus is provided and includes:
a first receiving module, configured to receive a service request data packet sent by a service request sending node, where the service request data packet includes first information, and the first information includes information of a target service requested by the service request sending node;
a first sending module, configured to send the first information to a first node, where the first information is used to determine a target service node that provides the target service;
a second receiving module, configured to receive information of the target service node sent by the first node; and
a forwarding module, configured to forward, to the target service node, the service request data packet sent by the service request sending node, and forward, to a service response receiving node, a service response data packet sent by the target service node for the service request data packet.

According to a sixth aspect, a computing service implementation apparatus is provided and includes:
a collection module, configured to collect second information of a service node, where the second information includes at least one of the following: service information and computational load information; and
a sending module, configured to send the second information to a first node, so that the second information is used to determine a target service node that provides a target service.

According to a seventh aspect, a communication device is provided. The communication device includes a processor and a memory. The memory stores a program or instructions capable of running on the processor. When the program or instructions are executed by the processor, the steps of the method according to the first aspect, the second aspect, or the third aspect are implemented.

According to an eighth aspect, a first node is provided and includes a processor and a communication interface. The processor is configured to: obtain first information, where the first information includes information of a target service requested by a service request sending node; and determine, based on the first information and second information, a target service node that provides the target service, where the second information includes at least one of the following: service information and computational load information of a service node.

According to a ninth aspect, a second node is provided and includes a processor and a communication interface. The communication interface is configured to: receive a service request data packet sent by a service request sending node, where the service request data packet includes first information, and the first information includes information of a target service requested by the service request sending node; send the first information to a first node, where the first information is used to determine a target service node that provides the target service; receive information of the target service node sent by the first node; and forward, to the target service node, the service request data packet sent by the service request sending node, and forward, to a service response receiving node, a service response data packet sent by the target service node for the service request data packet.

According to a tenth aspect, a third node is provided and includes a processor and a communication interface. The processor is configured to collect second information of a service node, where the second information includes at least one of the following: service information and computational load information. The communication interface is configured to send the second information to a first node, so that the second information is used to determine a target service node that provides a target service.

According to an eleventh aspect, a readable storage medium is provided. The readable storage medium stores a program or instructions. When the program or instructions are executed by a processor, the steps of the method according to the first aspect, the second aspect, or the third aspect are implemented.

According to a twelfth aspect, a chip is provided. The chip includes a processor and a communication interface. The communication interface is coupled to the processor. The processor is configured to run a program or instructions to implement the method according to the first aspect, the second aspect, or the third aspect.

According to a thirteenth aspect, a computer program or program product is provided. The computer program or program product is stored in a storage medium. The computer program or program product is executed by at least one processor to implement the steps of the method according to the first aspect, the second aspect, or the third aspect.

### BRIEF DESCRIPTION OF DRAWINGS

FIG. 1 is a block diagram of a wireless communication system to which an embodiment of this application may be applied;

FIG. 2 is a schematic flowchart of a computing service implementation method performed by a first node according to an embodiment of this application;

FIG. 3 is a schematic flowchart of a computing service implementation method performed by a second node according to an embodiment of this application;

FIG. 4 is a schematic flowchart of a computing service implementation method performed by a third node according to an embodiment of this application;

FIG. 5 is a schematic flowchart of a computing service implementation method according to Embodiment 1 of this application;

FIG. 6 is a first schematic flowchart of a computing service implementation method according to Embodiment 2 of this application;

FIG. 7 is a second schematic flowchart of a computing service implementation method according to Embodiment 2 of this application;

FIG. 8 is a first schematic diagram of a structure of a computing service implementation apparatus according to an embodiment of this application;

FIG. 9 is a second schematic diagram of a structure of a computing service implementation apparatus according to an embodiment of this application;

FIG. 10 is a third schematic diagram of a structure of a computing service implementation apparatus according to an embodiment of this application;

FIG. 11 is a schematic diagram of a structure of a communication device according to an embodiment of this application; and

FIG. 12 is a schematic diagram of a structure of a network-side device according to an embodiment of this application.

### DETAILED DESCRIPTION

The following clearly describes the technical solutions in the embodiments of this application with reference to the accompanying drawings in the embodiments of this application. Understandably, the described embodiments are only some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “and/or” in the specification and claims indicates at least one of connected objects, and the character “/” generally represents an “or” relationship between associated objects.

It should be noted that technologies described in the embodiments of this application are not limited to a Long Term Evolution (LTE)/LTE-Advanced (LTE-A) system, and can also be used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in the embodiments of this application are usually used interchangeably. The described technologies may be used for the foregoing systems and radio technologies, and may also be used for other systems and radio technologies. However, in the following descriptions, the new radio (NR) system is described for an illustrative purpose, and NR terms are used in most of the following descriptions. These technologies may also be applied to other applications than an NR system application, for example, a 6th Generation (6G) communication system.

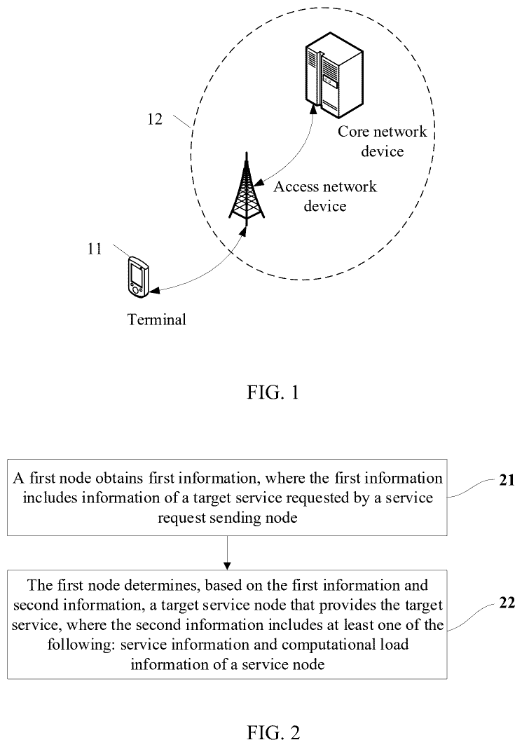

FIG. 1 is a block diagram of a wireless communication system to which an embodiment of this application may be applied. The wireless communication system includes a terminal 11 and a network-side device 12. The terminal 11 may be a terminal-side device such as a mobile phone, a tablet personal computer, a laptop computer or a notebook computer, a personal digital assistant (PDA), a palmtop computer, a netbook, an ultra-mobile personal computer (UMPC), a Mobile Internet Device (MID), an augmented reality (AR) or virtual reality VR) device, a robot, a wearable device, Vehicle User Equipment (VUE), Pedestrian User Equipment (PUE), a smart home (a home device having a wireless communication function, such as a refrigerator, a television, a washing machine, or furniture), a game console, a personal computer (PC), a teller machine, or a self-service machine. The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, or the like. It should be noted that a specific type of the terminal 11 is not limited in the embodiments of this application. The network-side device 12 may include an access network device or a core network device. The access network device may also be referred to as a radio access network device, a Radio Access Network (RAN), a radio access network function, or a radio access network element. The access network device may include a base station, a Wireless Local Area Network (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission and Reception Point (TRP), or another appropriate term in the art. As long as the same technical effect is achieved, the base station is not limited to specific technical terms. It should be noted that in the embodiments of this application, only a base station in an NR system is used as an example for description, but a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a Local NEF or L-NEF, a Binding Support Function (BSF), an Application Function (AF), or the like. It should be noted that in the embodiments of this application, only a core network device in the NR system is used as an example for description, but a specific type of the core network device is not limited.

6G is an information system integrating communication, computing, and storage. When a mobile network provides services such as computing and storage, how to select an appropriate service node for a service request of user equipment is a problem that needs to be resolved.

A computing service implementation method and apparatus, a communication device, and a readable storage medium provided in the embodiments of this application are hereinafter described in detail by using some embodiments and application scenarios thereof with reference to the accompanying drawings.

Referring to FIG. 2, an embodiment of this application provides a computing service implementation method, including:

Step 21: A first node obtains first information, where the first information includes information of a target service requested by a service request sending node.

Step 22: The first node determines, based on the first information and second information, a target service node that provides the target service, where the second information includes at least one of the following: service information and computational load information of a service node.

The second information is used to assist the first node in determining an appropriate target service node.

In this embodiment of this application, the service node may also be referred to as a service instance.

In this embodiment of this application, when the service request sending node requests the target service, an appropriate target service node for providing the target service is determined based on service information and/or computational load information of each service node. Examples of potential target service instances are an online conference, simultaneous interpretation, a virtual digital human, Augmented Reality (AR) or Virtual Reality (VR), Artificial Intelligence (AI) model training, AI inference, image recognition, video rendering, and the like.

In this embodiment of this application, optionally, the service node includes at least one of the following: an IP Multimedia Subsystem (IMS), a trusted Data Network (DN) node, a core network function node, a radio access network node, and user equipment (UE, which may also be referred to as a user terminal or a terminal). In other words, the service node is a node within a mobile network, not requiring transmission outside the mobile network, thereby saving external transmission resources and reducing delay costs.

In this embodiment of this application, optionally, that a first node obtains first information includes:
the first node receives a service request data packet sent by the service request sending node, where the service request data packet includes the first information; or
the first node receives the first information sent by a second node, where the second node is a node that receives a service request data packet sent by the service request sending node.

In this embodiment of this application, the following cases may be distinguished based on whether the first node receives a service request and whether the first node determines the service node.

Case 1: The first node receives the service request data packet and determines the service node.

For example, the first node is a UPF node.

Case 2: The first node does not receive the service request data packet (received by the second node), but determines the service node.

For example, the second node is a UPF node, and the first node is a Session Management Function (SMF) node.

In this embodiment of this application, optionally, the information of the target service includes a service identifier for identifying the target service.

In this embodiment of this application, optionally, the service identifier is an anycast Internet Protocol (IP) address, a Media Access Control (MAC) address, or an identifier defined by the 3rd Generation Partnership Project (3GPP). In this embodiment of this application, because functional procedures related to communication and computing services are all within the mobile network, the service identifier may not be limited to an anycast IP address in CFN/CAN, a MAC address, or the like, and an existing identifier of the 3GPP may be reused, or a new identifier may be added. Certainly, a method for representing the service identifier may not be limited to this, as long as the representation can be recognized by the service request sending node, the first node, and other participants based on a protocol.

In this embodiment of this application, optionally, the first information further includes at least one of the following: an identifier of the service request sending node and an identifier of a service response receiving node. In this embodiment of this application, the service request sending node and the service response receiving node may be the same node. The service request sending node and the service response receiving node may alternatively be different nodes.

In this embodiment of this application, optionally, the first information further includes at least one of the following:
a computational load metric required by the target service;
a computational delay required by the target service;
a response time required by the target service;
memory information required by the target service;
storage information required by the target service;
a network bandwidth required by the target service; and
a service duration required by the target service.

In this embodiment of this application, optionally, before the first node determines, based on the first information and the second information, the target service node that provides the target service, the method further includes:
the first node collects the second information; or
the first node receives the second information collected by a third node.

In this embodiment of this application, the first node may obtain the second information periodically and/or in an event-triggered manner.

In this embodiment of this application, optionally, the service information of the service node includes at least one of the following:

(1) A service identifier for identifying a service that the service node is capable of providing.

The service identifier is a unique ID for identifying a service.

In this embodiment of this application, optionally, the service identifier is an anycast IP address, a MAC address, or a 3GPP-defined identifier. In this embodiment of this application, because the functional procedures related to communication and computing services are all within the mobile network, the service identifier may not be limited to an anycast IP address in CFN/CAN, a MAC address, or the like, and an existing identifier of the 3GPP may be reused, or a new identifier may be added.

For example, the service identifier may be an anycast IP address or a predefined service identifier (for example, a specific IPv4 address negotiated by the service node, a router, and the first node; or for another example, a MAC address). In addition, it may be a data network name (DN name), a data network identifier, or a protocol-defined identifier, for example, a numerical value with a specified bit length, where 001 represents a CNN (convolutional neural network) training service, and 010 represents an RNN (recurrent neural network) training service, or the like.

(2) A service instance identifier for identifying the service node.

The service instance identifier is a unique ID for identifying a service instance.

In this embodiment of this application, optionally, the service instance identifier is an IP address, a MAC address, or a 3GPP-defined identifier. In this embodiment of this application, because the functional procedures related to communication and computing services are all within the mobile network, the service instance identifier may not be limited to an anycast IP address in CFN/CAN, a MAC address, or the like, and an existing identifier of the 3GPP may be reused, or a new identifier may be added.

For example, the service instance identifier may be a unicast IP address or a MAC address. In addition, an identifier within the mobile network (that is, a 3GPP-defined identifier) may be used. For example, when the service node is user equipment, a Subscription Permanent Identifier (SUPI), a Permanent Equipment Identifier (PEI), a generic public subscription identifier (GPSI), a private identity (e.g., IP Multimedia (IM) Private Identity, IMPI), or a public identity (e.g., IM Public Identity, IMPU) may be used. For example, when the service node is a network function, a network function ID such as an AMF instance ID or a gNB ID may be used.

The PEI is defined for 3GPP UE to enter a 5G system. If the UE supports at least one 3GPP access technology (that is, NG-RAN/5G, E-UTRAN/4G, UTRAN/3G, or GERAN/EDGE/2.5G), the UE needs to be assigned an international mobile equipment identity (international mobile equipment identity, IMEI, also known as a mobile phone serial number) or a PEI in a MEISV format.

The GPSI is used to handle EGPP users in different data networks (DNS) outside a 3GPP system. The 3GPP system maintains an association between the GPSI and the corresponding SUPI in a user data repository. The GPSI may be a Mobile Subscriber Integrated Services Digital Network (ISDN) Number (MSISDN) (commonly known as a mobile phone number), an external IP address, or the like.

The private identity (e.g., IM Private Identity, IMPI) and the public identity (e.g., IM Public Identity, IMPU) are two user identities owned by an IMS user.

The IMPI is used for registration, authentication, authentication, and accounting when the user accesses an IMS network. The private user identity is not used for addressing and routing of calls. A user identity defined by a home network operator is globally unique. One private identity corresponds to one physical terminal.

The IMPU is used for routing SIP messages. One IMS user may be assigned one or more public user identities, and a format of the public user identity may be a SIP URI or Tel URL format. Before the IMPU is used to initiate a session or as a session terminator, the IMPU should be registered first.

(3) A service availability time for identifying a time when the service node is capable of providing the service.

The service availability time may be a relative time or an absolute time. The relative time is, for example, one hour after a PDU session establishment/modification request (PDU session establishment/modification request) is initiated. The absolute time is, for example, 00:00 to 00:05.

(4) A service availability area for representing an area that the service node is capable of serving.

The service availability area may be represented by an area identifier defined in the network, such as a tracking area (TA), a radio access network based notification area (RAN-based Notification Area, RNA), or a cell, or may be geographical coordinates.

(5) A network cost to reach the service node.

Because there may be a plurality of routes to a service node, the network cost includes a next hop address and a corresponding network cost (such as a transmission delay or a network cost level). For example, a next hop is a CFN node 1 (or D-router 1), and a corresponding transmission delay in a bearer network is 30 ms; or a next hop is a CFN node 1 (or D-router 1), and a corresponding transmission cost level in a bearer network is 2 (which may mean that the delay is between 30 ms and 50 ms, where the definition of the cost level may vary depending on different situations, and only an example is provided herein); or a next hop is a UPF 1, and a corresponding transmission delay in the mobile network is 10 ms.

In this embodiment of this application, optionally, the service identifier and/or the service instance identifier is an IP address, a MAC address, or a 3GPP-defined identifier. In this embodiment of this application, because the functional procedures related to communication and computing services are all within the mobile network, the service identifier and/or the service instance identifier may not be limited to an anycast IP address in CFN/CAN, a MAC address, or the like, and an existing identifier of the 3GPP may be reused, or a new identifier may be added.

In this embodiment of this application, optionally, the computational load information includes a computational load metric, and the computational load metric is either a numerical value obtained by performing a weighted computation on a plurality of parameters, or a set of parameters.

The computational load metric is used to measure computational load of the service node. For ease of use, the computational load metric may be a numerical value obtained by performing a weighted computation on a plurality of parameters (such as central processing unit (CPU) or graphics processing unit (GPU) usage and/or a quantity of related sessions). For example, for an image recognition service, a service provider may define a digital value of service load by comprehensively considering bandwidth resources, a request quantity, and computing resources. Alternatively, the computational load metric may be a set of parameters including at least one of the following: CPU usage, CPU idle rate, service session usage, service session idle rate, quantity of CPUs in use, quantity of available CPUs, quantity of CPU cores in use, quantity of available CPU cores, quantity of sessions in use, quantity of available sessions, computational delay, quantity of requests per second, and used computing resources or available computing resources measured in units of Turing, hash rate, Tera operations per second (TOPS)/Giga operations per second (GOPS)/million operations per second (MOPS), or floating-point operations per second (FLOPS), and the like.

Depending on different designs, usually one service may be deployed on one or more servers. Usually, one server has a plurality of CPUs, and one CPU has a plurality of CPU cores.

The Turing Unit (TU), pioneered globally by the Turing Fog Foundation, is an objective unit for measuring computing power, defined for a production node.

The Hash rate, also known as computing power, is a unit for measuring a processing capability of a bitcoin network. It refers to a speed at which a CPU computes an output of a hash function. The bitcoin network needs to perform intensive mathematical and encryption-related operations for security purposes. For example, when the network reaches a hash rate of 10 Th/s, it means that the network can perform 10 trillion computations per second.

TOPS, GOPS, and MOPS are units for measuring a computational capability of a processor. 1 TOPS indicates that the processor can perform one trillion operations per second. It is generally used as a metric for measuring a computational capability of a CPU. 1 GOPS indicates that the processor can perform one billion operations per second. 1 MOPS indicates that the processor can perform one million operations per second.

FLOPS (floating-point operations per second) is the number of floating-point operations performed per second.

In this embodiment of this application, optionally, that the first node determines, based on the first information and second information, a target service node that provides the target service includes: the first node determines, based on the first information, the second information, and third information, the target service node that provides the target service, where the third information includes at least one of the following:
topology information and/or status information within a mobile network between the service request sending node and a target node;
topology information and/or status information within a mobile network between the service node and a target node; and
topology information and/or status information within a mobile network between the service response receiving node and a target node, where
when the first node is a node that receives a service request sent by the service request sending node, the target node is the first node; or
when the second node is a node that receives a service request sent by the service request sending node, the target node is the second node.

In this embodiment of this application, optionally, when the service request sending node, the service response receiving node, or the service node includes user equipment, the third information includes at least one of the following:
a serving base station (serving RAN node) of the user equipment;
the target node, where the target node is a UPF node;
an uplink delay between the user equipment and the serving base station;
a downlink delay between the user equipment and the serving base station;
a round trip delay between the user equipment and the serving base station;
an uplink delay between the serving base station and the target node;
a downlink delay between the serving base station and the target node;
a round trip delay between the serving base station and the target node;
an uplink bandwidth between the user equipment and the serving base station;
a downlink bandwidth between the user equipment and the serving base station;
an uplink bandwidth between the user equipment and the target node; and
a downlink bandwidth between the user equipment and the target node.

In this embodiment of this application, the serving base station may also be referred to as a radio access network node. The target node may be a UPF node, or a core network function node (such as a computing plane function or a data plane function) that carries computing services.

In this embodiment of this application, optionally, when the service request sending node, the service response receiving node, or the service node includes a fourth node, the third information includes at least one of the following:
an uplink delay between the fourth node and the target node;
a downlink delay between the fourth node and the target node;
a round trip delay between the fourth node and the target node;
an uplink bandwidth between the fourth node and the target node; and
a downlink bandwidth between the fourth node and the target node, where
the fourth node includes at least one of the following: an IMS, a trusted data network node, a core network function node, or a radio access network node.

It should be noted that the uplink delay between the fourth node and the target node refers to a delay in a case of sending by the fourth node and reception by the target node; and the downlink delay between the fourth node and the target node refers to a delay in a case of sending by the target node and reception by the fourth node.

Similarly, the uplink bandwidth between the fourth node and the target node refers to a bandwidth in a case of sending by the fourth node and reception by the target node; and the downlink bandwidth between the fourth node and the target node refers to a bandwidth in a case of sending by the target node and reception by the fourth node.

The delay in this embodiment of this application may be real-time delay measurement information, historical delay information, or delay information predicted for a future period based on historical data. The delay may be a maximum delay, a minimum delay, an average delay, or the like.

In this embodiment of this application, optionally, before the first node determines, based on the first information, the second information, and the third information, the target service node that provides the target service, the method further includes: the first node obtains the third information.

In this embodiment of this application, optionally, that the first node obtains the third information includes:
the first node obtains the third information periodically and/or in an event-triggered manner; or
the first node obtains the third information after obtaining the first information.

In this embodiment of this application, optionally, after the first node determines, based on the first information and the second information, the target service node that provides the target service, the method further includes:
the first node sends information of the target service node to a second node, where the second node is a node that receives a service request data packet sent by the service request sending node.

In this embodiment of this application, optionally, the information of the target service node includes an IP address of the target service node; and before the first node sends the information of the target service node to the second node, the method further includes: the first node converts a 3GPP-defined identifier of the target service node into an IP address.

In this embodiment of this application, optionally, after the first node determines, based on the first information and the second information, the target service node that provides the target service, the method further includes: when the first node is a node that receives a service request data packet sent by the service request sending node, forwarding, to the target service node, the service request data packet sent by the service request sending node, and forwarding, to a service response receiving node, a service response data packet sent by the target service node for the service request data packet.

In this embodiment of this application, optionally, the method further includes:
the first node forwards, to the target service node based on a mapping relationship, a subsequent data packet that is of a service flow and that is sent by the service request sending node, and forwards, to the service response receiving node, a response data packet sent by the target service node for the subsequent data packet of the service flow, where the mapping relationship is a mapping relationship between the service flow of the target service and the target service node.

In this embodiment of this application, the service request data packet is a first data packet of the service flow, and the subsequent data packet is a data packet following the service request data packet in the service flow, such as a second data packet or a third data packet.

In this embodiment of this application, the service node is determined only when the first data packet (that is, the service request data packet) of the service flow is received, rather than being determined every time a data packet is received. In this way, a delay caused by determining the service node for each subsequent data packet is avoided. Processing of the same service flow by the same service node is also beneficial to continuity and consistency of service performance.

In this embodiment of this application, optionally, in the mapping relationship:
the service flow of the target service is identified by using the following information: an identifier of the service request sending node, an identifier of the service response receiving node, and a PDU session identifier and a QoS flow identifier corresponding to the target service; or
the service flow of the target service is identified by using the following information: an IP address and/or a port of the service request sending node, and an IP address and/or a port of the service response receiving node; or
the service flow of the target service is identified by using the following information: an IP address and/or a port of the service request sending node, and an IP address and/or a port of the target service node; or
the service flow of the target service is identified by using the following information: a QoS flow identifier.

In this embodiment of this application, optionally, the forwarding, to the target service node, the service request data packet sent by the service request sending node includes one of the following:
if a source IP address in the service request data packet is a private IP address of the service request sending node, the first node sets the source IP address to a public IP address and port number of the service request sending node, and saves a mapping relationship between the private IP address and port number and the public IP address and port number, so that when a data packet with a destination address being the public IP address and port number is received, the public IP address and port number can be demapped to the private IP address and port number of the corresponding service request sending node; and
the first node adds public address information, and sets a source IP address of the public address information to an IP address of the first node or an identifier of the first node, and sets a destination IP address of the public address information to an IP address of a UPF node of the target service node, or sets a destination IP address of the public address information to a service instance identifier of the target service node.

Referring to FIG. 3, an embodiment of this application further provides a computing service implementation method, including:

Step 31: A second node receives a service request data packet sent by a service request sending node, where the service request data packet includes first information, and the first information includes information of a target service requested by the service request sending node.

Step 32: The second node sends the first information to a first node, where the first information is used to determine a target service node that provides the target service.

Step 33: The second node receives information of the target service node sent by the first node.

Step 34: The second node forwards, to the target service node, the service request data packet sent by the service request sending node, and forwards, to a service response receiving node, a service response data packet sent by the target service node for the service request data packet.

In this embodiment of this application, after receiving the service request data packet sent by the service request sending node, the second node itself does not determine the target service node for providing the target service, but requests the first node to determine the target service node for providing the target service, and receives the target service node determined by the first node, so as to forward the data packet between the service request sending node and the target service node, and forward the data packet between the target service node and the service response receiving node.

In this embodiment of this application, optionally, the information of the target service includes a service identifier for identifying the target service.

In this embodiment of this application, optionally, the service identifier is an anycast IP address, a MAC address, or a 3GPP-defined identifier.

In this embodiment of this application, optionally, the first information further includes at least one of the following: an identifier of the service request sending node and an identifier of the service response receiving node.

In this embodiment of this application, optionally, the first information further includes at least one of the following:
a computational load metric required by the target service;
a computational delay required by the target service;
a response time required by the target service;
memory information required by the target service;
storage information required by the target service;
a network bandwidth required by the target service; and
a service duration required by the target service.

In this embodiment of this application, optionally, the method further includes:
the second node forwards, to the target service node based on a mapping relationship, a subsequent data packet that is of a service flow and that is sent by the service request sending node, and forwards, to the service response receiving node, a response data packet sent by the target service node for the subsequent data packet of the service flow, where the mapping relationship is a mapping relationship between the service flow of the target service and the target service node.

In this embodiment of this application, optionally, in the mapping relationship:
the service flow of the target service is identified by using the following information: an identifier of the service request sending node, an identifier of the service response receiving node, and a PDU session identifier and a QoS flow identifier corresponding to the target service; or
the service flow of the target service is identified by using the following information: an IP address and/or a port of the service request sending node, and an IP address and/or a port of the service response receiving node; or
the service flow of the target service is identified by using the following information: an IP address and/or a port of the service request sending node, and an IP address and/or a port of the target service node; or
the service flow of the target service is identified by using the following information: a QoS flow identifier.

In this embodiment of this application, optionally, the forwarding, to the target service node, the service request data packet sent by the service request sending node includes one of the following:
if a source IP address in the service request data packet is a private IP address of the service request sending node, the second node sets the source IP address to a public IP address and port number of the service request sending node, and saves a mapping relationship between the private IP address and port number and the public IP address and port number, so that when a data packet with a destination address being the public IP address and port number is received, the public IP address and port number can be demapped to the private IP address and port number of the corresponding service request sending node; and
the second node adds public address information, and sets a source IP address of the public address information to an IP address of the second node or an identifier of the second node, and sets a destination IP address of the public address information to an IP address of a UPF node of the target service node, or sets a destination IP address of the public address information to a service instance identifier of the target service node.

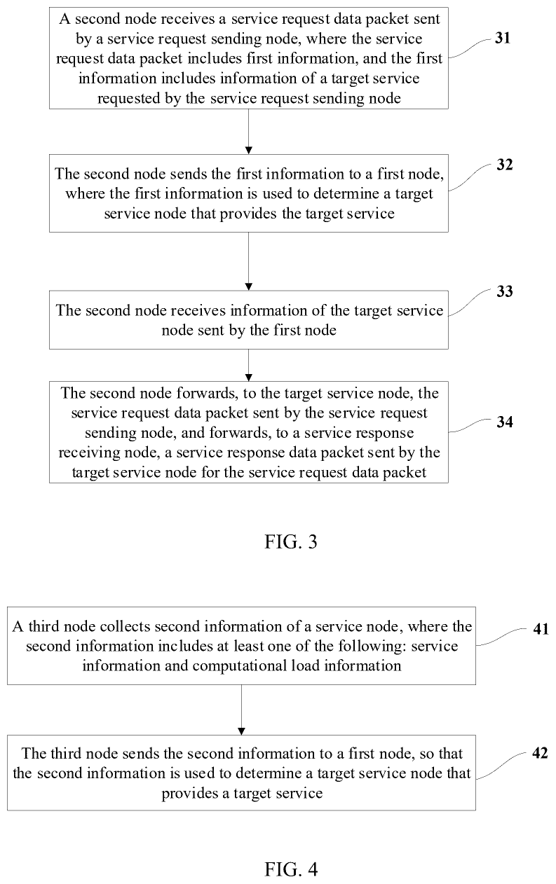

Referring to FIG. 4, an embodiment of this application further provides a computing service implementation method, including:

Step 41: A third node collects second information of a service node, where the second information includes at least one of the following: service information and computational load information.

Step 42: The third node sends the second information to a first node, so that the second information is used to determine a target service node that provides a target service.

In this embodiment of this application, the third node collects the service information and/or the computational load information of the service node and sends the information to the first node, to assist the first node in determining the target service node that provides the target service.

In this embodiment of this application, optionally, the service information includes at least one of the following:
a service identifier for identifying a service that the service node is capable of providing;
a service instance identifier for identifying the service node;
a service availability time for identifying a time when the service node is capable of providing the service;
a service availability area for representing an area that the service node is capable of serving; and
a network cost to reach the service node.

In this embodiment of this application, optionally, the service identifier and/or the service instance identifier is an IP address, a MAC address, or a 3GPP-defined identifier.

In this embodiment of this application, optionally, the computational load information includes a computational load metric, and the computational load metric is either a numerical value obtained by performing a weighted computation on a plurality of parameters, or a set of parameters.

The computing service implementation methods in the embodiments of this application may be used in different service flow scenarios:
1. a scenario of terminal computation offloading, in which terminal A sends a service request and a service response is returned to terminal A (that is, a service request sending node and a service response receiving node are the same node);
2. a scenario of integrated communication and computing between terminals, in which terminal A sends a service request and a service response is provided to terminal B;
3. a scenario of integrated communication and computing between a terminal and an application function or an application server, in which terminal A sends a service request and a service response is provided to the application function or the application server; and
4. a scenario of integrated communication and computing between a terminal and an application function or an application server, in which the application function or the application server sends a service request and a service response is provided to terminal A.

The following describes the computing service implementation methods in the foregoing scenarios by using examples.

### Embodiment 1

A scenario in this embodiment is the foregoing scenario of terminal computation offloading, in which a first node does not receive a service request but determines a service node.

This embodiment is based on existing 5G network functions. It is assumed that the first node is a computing service management function (the first node may also be another network function, such as an AMF or an SMF) added based on existing protocol functions.

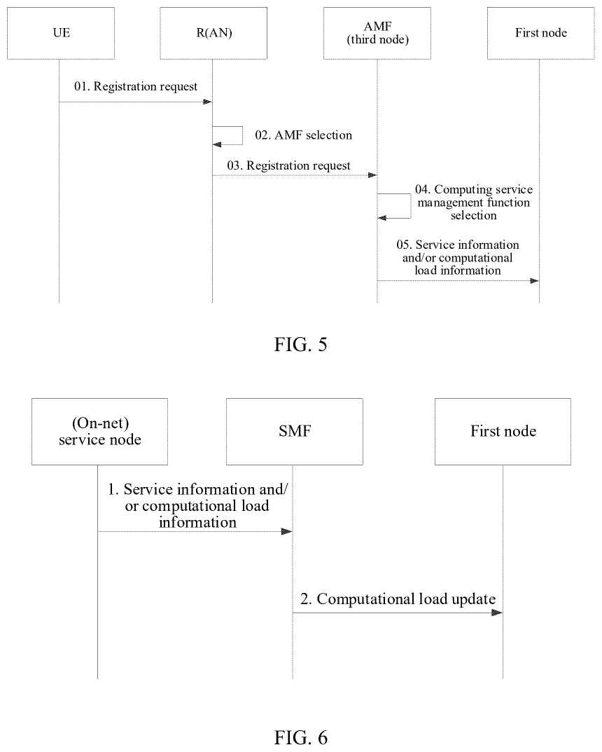

Referring to FIG. 5, a computing service implementation method in this embodiment of this application includes the following steps.

Step 01: When UE can provide a computing service, the UE may carry second information in a registration request (Registration request), where the second information includes service information and/or computational load information.

Steps 02 to 05: A radio access network (Radio (Access Network), R (AN)) node and/or an AMF selects, based on the second information, a computing service management function (first node) supporting collection of the second information, and sends the service information and/or the computational load information of the UE to the first node.

In this embodiment of this application, the second information may alternatively be collected and provided to the first node by a plurality of network functions. For example, the computing service management function is responsible for collecting and providing the service information of the UE, and the SMF is responsible for collecting and providing the computational load information of the UE.

The service information includes at least one of the following:

(1) A service identifier for identifying a service that a service node is capable of providing.

The service identifier is a unique ID for identifying a service.

In this embodiment of this application, optionally, the service identifier is an anycast IP address, a MAC address, or a 3GPP-defined identifier. In this embodiment of this application, because functional procedures related to communication and computing services are all within a mobile network, the service identifier may not be limited to an anycast IP address in CFN/CAN, a MAC address, or the like, and an existing identifier of the 3GPP may be reused, or a new identifier may be added.

For example, the service identifier may be an anycast IP address or a predefined service identifier (for example, a specific IPv4 address negotiated by the service node, a router, and the first node; or for another example, a MAC address). In addition, it may be a data network name (DN name), a data network identifier, or a protocol-defined identifier, for example, a numerical value with a specified bit length, where 001 represents a Convolutional Neural Network (CNN) training service, and 010 represents a Recurrent Neural Network (RNN) training service, or the like.

(2) A service instance identifier for identifying the service node.

The service instance identifier is a unique ID for identifying a service instance.

In this embodiment of this application, optionally, the service instance identifier is an IP address, a MAC address, or a 3GPP-defined identifier. In this embodiment of this application, because the functional procedures related to communication and computing services are all within the mobile network, the service instance identifier may not be limited to an anycast IP address in CFN/CAN, a MAC address, or the like, and an existing identifier of the 3GPP may be reused, or a new identifier may be added.

For example, the service instance identifier may be a unicast IP address or a MAC address. In addition, an identifier within the mobile network (that is, a 3GPP-defined identifier) may be used. For example, when the service node is user equipment, a Subscription Permanent Identifier (SUPI), a Permanent Equipment Identifier (PEI), a generic public subscription identifier (GPSI), a private identity (e.g., IM Private Identity, IMPI), or a public identity (e.g., IM Public Identity, IMPU) may be used. For example, when the service node is a network function, a network function ID such as an AMF instance ID or a gNB ID may be used.

(3) A service availability time for identifying a time when the service node is capable of providing the service.

The service availability time may be a relative time or an absolute time. The relative time is, for example, one hour after a PDU session establishment/modification request (PDU session establishment/modification request). The absolute time is, for example, 00:00 to 00:05.

(4) A service availability area for representing an area that the service node is capable of serving.

The service availability area may be represented by an area identifier defined in the network, such as a Tracking Area (TA), a RAN-based Notification Area (RNA), or a cell, or may be geographical coordinates.

(5) A network cost to reach the service node.

The computational load metric is used to measure computational load of the service node. For ease of use, the computational load metric may be a numerical value obtained by performing a weighted computation on a plurality of parameters (such as CPU/GPU (Graphics Processing Unit) usage and/or a quantity of related sessions). For example, for an image recognition service, a service provider may define a digital value of service load by comprehensively considering bandwidth resources, a request quantity, and computing resources. Alternatively, the computational load metric may be a set of parameters including at least one of the following: CPU usage, CPU idle rate, service session usage, service session idle rate, quantity of CPUs in use, quantity of available CPUs, quantity of CPU cores in use, quantity of available CPU cores, quantity of sessions in use, quantity of available sessions, computational delay, quantity of requests per second, and used computing resources or available computing resources measured in units of Turing, hash rate, TOPS/GOPS/MOPS, or FLOPS, and the like.

It should be noted that when an IMS, a trusted data network node, a core network function node, or a radio access network node provides services, a service registration/update/deregistration/withdrawal message carrying service information and computational load information may be sent to the first node. Service registration is used to register, with the first node, a new service that the service node is capable of providing. Service update is used to update registered service information with the first node. Service deregistration/withdrawal is used to deregister a registered service from the first node. Computational load information is used to provide the first node with current computational load metric information of a service.

In a scenario of an integrated communication and computing service, the computing service implementation method in this embodiment of this application further includes:

Step 1: A second node (such as a UPF) receives a service request data packet sent by the UE, and determines, based on information in the service request data packet, whether network assistance is required for selecting an appropriate service node. If yes, the second node proceeds to step 2.

Step 2: The second node sends a UE identifier of the UE sending the service request data packet, service information (such as a SID), an identifier of a service response receiving node, and the like to the first node, requesting to determine an appropriate service node.

Step 3: The first node (computing service management function) determines the service node (such as the AMF instance ID or the gNB ID) based on the service information requested by the UE and the second information of the service node within the mobile network. If the second node cannot recognize the 3GPP-defined identifier used by the service node when the service node is registered, which is provided by the service node, the first node is responsible for converting the 3GPP-defined identifier (such as the gNB ID or the AMF instance ID) into an IP address. The first node sends information of the determined service node (including at least the service instance identifier) to the second node.

Step 4: The second node forwards the service request data packet based on the received information of the service node, and saves a mapping relationship between a service flow and the information of the service node, to ensure that the same route and service node are used for subsequent data transmission of the service.

The mapping relationship can identify the service flow or the service node (service instance) by using the 3GPP-defined identifier, and can also identify the service flow or the service node by using IP addresses (including private and public IP addresses).

A representation of the mapping relationship is shown in Table 1.

TABLE 1

| Flow identifier (service | | | Valid |
|---|---|---|---|
| flow identifier) | Service instance ID | | duration |
| UE ID | IP address M | Port number N | K |
| PDU session ID | | | |
| QoS flow ID X | | | |
| UE ID | IP address O | Port number P | L |
| PDU session ID | | | |
| QoS flow ID Y | | | |

Another representation of the mapping relationship is shown in Table 2.

TABLE 2

| | | | | | | | Valid |
|---|---|---|---|---|---|---|---|
| Flow identifier (service flow identifier) | | | | | Service instance ID | | duration |
| Source | Destination | Source | Destination | Protocol | IP | Port | K |
| IP # | IP # | port # | port # | (such as | address | number | |
| | | | | TCP) | M | N | |

Another representation of the mapping relationship is shown in Table 3.

TABLE 3

| Flow identifier (flow | | |
|---|---|---|
| identifier) | Service instance ID | Valid duration |
| QoS flow ID X | AMF instance ID | K |
| QoS flow ID Y | gNB ID | L |

Step 5: Optionally, the second node may translate the destination or source address in the service request data packet. If a source IP address (inner: src IP) in the service request data packet is a private IP address (or local IP address) of the UE, the second node may set the source address to a public IP address and port number of the UE.

Other address translation modes are as follows: For example, in one address translation mode, the second node sets an external source address (outer: src IP) to an IP address of the second node or an ID of the second node (for example, an SMF instance ID); and if the determined service instance is routed by another UPF, an external destination address (outer: dst IP) is set to an IP address of the UPF node routable to the determined service instance. For another example, in another translation mode, if the second node sets the destination address (outer: dst IP) to the identifier of the determined service instance (that is, a unicast IP address in a one-to-one correspondence with the service instance), such as the gNB ID. Depending on the determined service instance, the second node may directly send the service request data packet to the service instance, or the second node may send the service request data packet to a UPF node that is connected to the second node and routable to the service instance, or the like.

Step 6: After completing processing, the service node sends a service response data packet. Correspondingly, the second node receives the service response data packet. If the second node has performed address translation, the second node needs to perform corresponding inverse mapping after receiving the service response data packet, and send the service response data packet to the UE. For example, outer address information is removed, and the destination address is translated into the IP address of the UE.

The second node receives a subsequent packet of the service sent by the UE, and uses the same processing mode and forwarding mode based on the stored mapping relationship, thereby ensuring consistency of service performance, which may also be referred to as flow affinity.

### Embodiment 2

A scenario in this embodiment is the foregoing scenario of terminal computation offloading, in which a first node receives a service request and determines a service node.

This embodiment is based on existing 5G network functions. It is assumed that the first node is a UPF (the first node may also be another network function, such as a 6G user plane function or a new computing service function).

A method for the first node (UPF) to obtain service information and/or computational load information within a network is to obtain service information and/or computational load information of the service node from a control plane node (such as an SMF, that is, the foregoing third node). Another method is as follows: If the service node is UE, the UE may send service information and/or computational load information to the UPF (first node) by using a user plane protocol header extension; or if the service node is a network function, the network function may also send service information and/or computational load information to the UPF (first node) by using a protocol header extension of a transport network layer (TNL). For example, a core network control plane function may send service information and/or computational load information to the UPF (first node) by using an N4 interface protocol extension.

Referring to FIG. 6, the first node may obtain and continuously track the service information and/or the computational load information within the network by using a procedure shown in FIG. 6.

Table 4 shows a type of service information and computational load information. Table 4 is for example only. A numerical value obtained by performing a weighted computation on a plurality of parameters is used as an example for both the computational load and network status. A larger computational load value indicates heavier load, and a larger network status value indicates that a greater cost (such as a delay) is required for network transmission.

TABLE 4

| | On-net | | Off-net | | | |
|---|---|---|---|---|---|---|
| On-net | service | Off-net | service | | | Next-hop |
| service | instance | service | instance | Computational | Network | routing device |
| identifier | identifier | identifier | identifier | load | status | identifier |
| 001 | AMF | Anycast | Unicast IP | 5 | 2 | IP address or |
| | instance | IP address | address 1 | | | on-net function |
| | ID | 1 | | | | identifier |
| 010 | gNB ID | Anycast | Unicast IP | 3 | 3 | IP address or |
| | | IP address | address 2 | | | on-net function |
| | | 2 | | | | identifier |

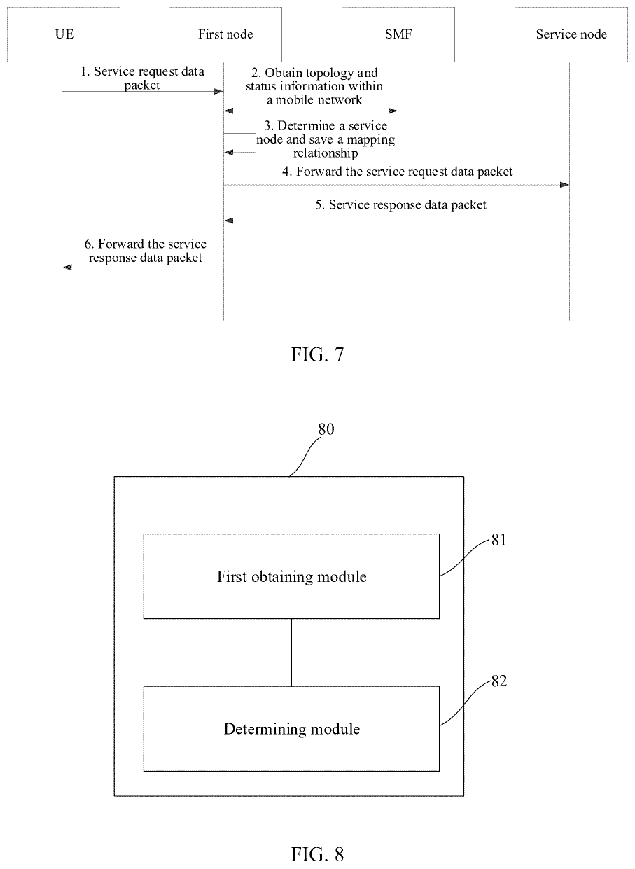

In a scenario of an integrated communication and computing service (such as the foregoing online conference or simultaneous interpretation), referring to FIG. 7, a computing service implementation method in this embodiment of this application includes the following steps (where a first node is an SMF, and the first node also obtains topology and status information within a mobile network).

Step 1: A first node receives a service request data packet sent by UE, and determines, based on information (for example, a destination IP address) in the service request data packet, whether the first node needs to assist in selecting an appropriate service node. If yes, the first node proceeds to step 2. In this embodiment, the first node determines, based on the information in the service request data packet, that a node sending a service request and a node receiving a service response are the same node.

Step 2: Optionally, the first node obtains topology and status information within a mobile network between the UE and the first node.

Step 3: The first node determines a target service node (that is, a service instance identifier) based on information (such as a service ID represented by an IP address) in the service request data packet, latest service information and/or computational load information of a service node in the network obtained by the first node, topology and status information of the user equipment within the mobile network, and the like, and saves a mapping relationship between a service flow of the service and the target service node. This embodiment may also support a scenario in which a service request sending node is different from a service response receiving node. Therefore, compared with Embodiment 1, information of the service response receiving node can be added in the mapping relationship. Based on the mapping relationship, the first node can ensure that the same route and service node are used for subsequent data transmission of the service.

A mapping table is shown in Table 5. For example, source IP 1 or port 1 identifies the service request sending node, and source IP 2 or port 2 identifies the service response receiving node.

TABLE 5

| | | | | | | | | | Valid |
|---|---|---|---|---|---|---|---|---|---|
| Flow identifier | | | | | | | Service instance ID | | duration |
| Source | Source | Destination | Source | Source | Destination | Protocol | IP address | Port | K |
| IP 1 # | IP 2 # | IP # | port 1 # | port 2 # | port # | (such as | M | number | |
| | | | | | | TCP) | | N | |

Step 4: Optionally, the first node may translate the destination or source address in the service request data packet. If a source IP address (inner: src IP) in the service request data packet is a private IP address of the UE, the first node may set the source address to a public IP address and port number of the UE.

Other address translation modes are as follows: For example, in one address translation mode, if a determined service instance is routed by the first node or another UPF, an external destination address (outer: dst IP) is set to an IP address of a UPF node routable to the determined service instance. For another example, in another translation mode, the first node sets the destination address (outer: dst IP) to an identifier of the determined service instance (that is, a unicast IP address in a one-to-one correspondence with the service instance), such as a gNB ID. Depending on the determined service instance, the first node may directly send the service request to the service instance, or the first node may send the service request data packet to a UPF that is connected to the first node and routable to the service instance, or the like.

Step 5: After completing processing, the service node sends a service response data packet.

Step 6: The first node receives the service response data packet. If the first node has performed address translation, the first node needs to perform corresponding inverse mapping after receiving the service response data packet, and send the service response data packet to the UE. For example, the inverse mapping is: removing outer address information and translating the destination address into the private IP address of the service response receiving node UE.

The first node receives a subsequent packet of the service sent by the UE, and uses the same processing mode and forwarding mode based on the stored mapping relationship, thereby ensuring consistency of service performance, which may also be referred to as flow affinity.

### Embodiment 3

### Scenario 4: Communication and Computing Service Between UEs+First Node

The scenario in this embodiment is the foregoing scenario of a communication and computing service between UEs.

This embodiment is based on existing 5G network functions. It is assumed that a third node is an SMF (the third node may also be another network function, such as an AMF or a new computing service function). The third node obtains service information and/or computational load information within a network.

Optionally, the third node may also obtain topology and status information of the UE within the network. One method for obtaining the topology and status information of the UE within the network is as follows: The third node determines, based on information such as a UE capability and/or a protocol data unit (PDU) session type, a UE identifier set that potentially requires network assistance to select a more appropriate service node. The third node collects the topology and status information of the UE within the network periodically and/or in an event-triggered manner, thereby maintaining latest topology and status information within the network. Another method for the third node to obtain the topology and status information of the UE within the network is as follows: When the third node receives a PDU session request sent by the UE, the third node obtains the topology and status of the UE within the network instead of maintaining the information all the time.

The third node sends the service information and/or the computational load information periodically or in an event-triggered manner, or sends the service information, the computational load information, and the topology and status information within the network to a first node. Steps are as follows:

Step 01: The UE sends a PDU session establishment/modification (PDU session establishment/modification) request to the SMF (third node), where the PDU session establishment/modification request indicates that the UE may potentially require network assistance to select a more appropriate service node. Optionally, the PDU session establishment/modification request may further include information of a service requested by the UE, such as a SID or a SID list.

Step 02: The SMF sends status information (such as a delay) measurement request to a radio access network node (such as a gNB) and a UPF through N2 and N4 interfaces respectively based on the information received from the UE, so as to obtain topology and status information of the UE within a mobile network.

Step 03: The SMF selects, based on the obtained topology and status information of the UE within the mobile network, a UPF that supports network-assisted selection of a better service node, and completes the PDU session establishment or modification.

Step 04: The SMF sends the obtained service information and computational load information to the first node periodically, in an event-triggered manner, or based on a subscription. Optionally, the SMF may also send the topology and status information within the mobile network to the first node.

In a scenario of an integrated communication and computing service, the computing service implementation method includes:

Step 1: The first node (such as the UPF) receives a service request data packet sent by the UE, and determines, based on information in the service request data packet, whether the service request requires network assistance for selecting a more appropriate service node. If yes, the first node proceeds to step 2.

Step 2: The first node determines a target service node (such as a BID) based on service information requested by the UE, and the service information and/or computational load information of the service node within the network and the topology and status information of the UE within the mobile network that are obtained from the third node.

Step 3: The first node saves a mapping relationship between a service flow and the target service node based on the determined target service node, to ensure that the same route and service node are used for subsequent data transmission of the service.

Step 4: Optionally, the first node may translate a destination or source address in the service request data packet. If a source IP address (inner: src IP) in the service request data packet is a private IP address of the UE, the first node may set the source address to a public IP address and port number of UE that receives a response.

Other address translation modes are as follows: For example, in one address translation mode, if a determined service instance is routed by the first node or another UPF, an external destination address (outer: dst IP) is set to an IP address of a UPF node routable to the determined service instance. For another example, in another translation mode, if the first node sets the destination address (outer: dst IP) to an identifier of a determined service instance (that is, a unicast IP address in a one-to-one correspondence with the service instance), such as a gNB ID. Depending on the determined service instance, the first node may directly send the service request data packet to the service instance, or the first node may send the service request data packet to a UPF that is connected to the first node and routable to the service instance, or the like.

Step 5: After completing processing, the service node sends a service response data packet. Correspondingly, the first node receives the service response data packet. If the first node has performed address translation, the first node needs to perform corresponding inverse mapping after receiving the service response data packet, and send the service response data packet to the UE. For example, outer address information is removed, and the destination address is translated into a private IP address of a service response receiving node (for example, the UE).

The first node receives a subsequent packet of the service sent by the UE, and uses the same processing mode and forwarding mode based on the stored mapping relationship, thereby ensuring consistency of service performance, which may also be referred to as flow affinity.

### Embodiment 4

A scenario in this embodiment is the foregoing scenario of a communication and computing service between UE and an application function.

This embodiment is based on existing 5G network functions. It is assumed that a first node is a UPF (the first node may also be another network function, such as a 6G user plane function or a new computing service function).

A method for the first node (UPF) to obtain service information and/or computational load information within a network is to obtain service information and/or computational load information of a service node from a control plane node (such as an SMF, that is, the foregoing third node). Another method is as follows: If the service node is UE, the UE may send service information and/or computational load information to the UPF (first node) by using a user plane protocol header extension; or if the service node is a network function, the network function may also send service information and/or computational load information to the UPF (first node) by using a protocol header extension of a transport network layer (TNL). For example, a core network control plane function may send service information and/or computational load information to the UPF (first node) by using an N4 interface protocol extension.

In a scenario of an integrated communication and computing service, a computing service implementation method in an embodiment of this application includes the following steps (where a first node is an SMF, and the first node also obtains topology and status information within a mobile network).

Step 1: A second node receives a service request data packet sent by UE, and determines, based on information (for example, a destination IP address) in the service request data packet, whether a first node needs to assist in selecting an appropriate service node. If yes, the second node proceeds to step 2. In this embodiment, the first node determines, based on the information in the service request data packet, that a node sending a service request and a node receiving a service response are the same node.

Step 2: The second node sends a service node selection request message to the first node, where the service node selection request message includes a requested service identifier, computational load information required by a requested service, and the like.

Step 3: Optionally, the first node obtains topology and status information within a network from the UE to the second node and topology and status information within a network from the potential service node to the second node.

Step 4: The first node determines a target service node (that is, a service instance identifier) based on the obtained information, and sends information of the determined target service node to the second node.

Step 5: The second node forwards the service request data packet based on the received information of the target service node, and saves a mapping relationship between a service flow and the target service node.

This embodiment may also support a scenario in which a service request sending node is different from a service response receiving node. Therefore, compared with Embodiment 1, the service response receiving node can be added in the mapping relationship. Based on the mapping relationship, the second node can ensure that the same route and service node are used for subsequent data transmission of the service.

Step 6: Optionally, the second node may translate a destination or source address in the service request data packet. If a source IP address (inner: src IP) in the service request data packet is a private IP address of the UE, the second node may set the source address to a public IP address and port number of an application function. Other address translation modes are as follows: For example, in one address translation mode, if a determined service instance is routed by the second node or another UPF, an external destination address (outer: dst IP) is set to an IP address of a UPF node routable to the determined service instance. For another example, in another translation mode, if the second node sets the destination address (outer: dst IP) to an identifier of a determined service instance (that is, a unicast IP address in a one-to-one correspondence with the service instance), such as a gNB ID. Depending on the determined service instance, the second node may directly send the service request data packet to the service instance, or the second node may send the service request data packet to a UPF that is connected to the second node and routable to the service instance, or the like.

Step 7: After completing processing, the service node sends a service response data packet. Correspondingly, the second node receives the service response data packet. If the second node has performed address translation, the second node needs to perform corresponding inverse mapping after receiving the service response data packet, and send the service response data packet to the application function. For example, outer address information is removed, and the destination address is translated into an IP address of the service response receiving node, that is, the application function.

The second node receives a subsequent packet of the service sent by the UE, and uses the same processing mode and forwarding mode based on the stored mapping relationship, thereby ensuring consistency of service performance, which may also be referred to as flow affinity (flow affinity).

The computing service implementation method provided in the embodiments of this application may be performed by a computing service implementation apparatus. A computing service implementation apparatus provided in the embodiments of this application is described by assuming that the computing service implementation method is performed by the computing service implementation apparatus in the embodiments of this application.

Referring to FIG. 8, an embodiment of this application further provides a computing service implementation apparatus 80, including:
a first obtaining module 81, configured to obtain first information, where the first information includes information of a target service requested by a service request sending node; and
a determining module 82, configured to determine, based on the first information and second information, a target service node that provides the target service, where the second information includes at least one of the following: service information and computational load information of a service node.

In this embodiment of this application, when the service request sending node requests the target service, an appropriate target service node for providing the target service is determined based on service information and/or computational load information of each service node.

Optionally, the service node includes at least one of the following: an IMS, a trusted data network node, a core network function node, a radio access network node, and user equipment.

Optionally, the first obtaining module 81 is configured to receive a service request data packet sent by the service request sending node, where the service request data packet includes the first information; or
the first obtaining module 81 is configured to receive the first information sent by a second node, where the second node is a node that receives a service request data packet sent by the service request sending node.

Optionally, the information of the target service includes a service identifier for identifying the target service.

Optionally, the service identifier is an Internet Protocol IP address, a MAC address, or a 3GPP-defined identifier.

Optionally, the first information further includes at least one of the following: an identifier of the service request sending node and an identifier of a service response receiving node.

Optionally, the first information further includes at least one of the following: a computational load metric required by the target service;
a computational delay required by the target service;
a response time required by the target service;
memory information required by the target service;
storage information required by the target service;
a network bandwidth required by the target service; and
a service duration required by the target service.

Optionally, the computing service implementation apparatus 80 further includes:
a collection module, configured to collect the second information; or
a first receiving module, configured to receive the second information collected by a third node.

Optionally, the service information of the service node includes at least one of the following:
a service identifier for identifying a service that the service node is capable of providing;
a service instance identifier for identifying the service node;
a service availability time for identifying a time when the service node is capable of providing the service;
a service availability area for representing an area that the service node is capable of serving; and
a network cost to reach the service node.

Optionally, the service identifier and/or the service instance identifier is an IP address, a MAC address, or a 3GPP-defined identifier.

Optionally, the computational load information includes a computational load metric, and the computational load metric is either a numerical value obtained by performing a weighted computation on a plurality of parameters, or a set of parameters.

Optionally, the determining module 82 is configured to determine, based on the first information, the second information, and third information, the target service node that provides the target service, where the third information includes at least one of the following:
topology information and/or status information within a mobile network between the service request sending node and a target node;
topology information and/or status information within a mobile network between the service node and a target node; and
topology information and/or status information within a mobile network between the service response receiving node and a target node, where
when the first node is a node that receives a service request sent by the service request sending node, the target node is the first node; or
when a second node is a node that receives a service request sent by the service request sending node, the target node is the second node.

Optionally, when the service request sending node, the service response receiving node, or the service node includes user equipment, the third information includes at least one of the following:
a serving base station of the user equipment;
the target node, where the target node is a user plane function UPF node;
an uplink delay between the user equipment and the serving base station;
a downlink delay between the user equipment and the serving base station;
a round trip delay between the user equipment and the serving base station;
an uplink delay between the serving base station and the target node;
a downlink delay between the serving base station and the target node;
a round trip delay between the serving base station and the target node;
an uplink bandwidth between the user equipment and the serving base station;
a downlink bandwidth between the user equipment and the serving base station;
an uplink bandwidth between the user equipment and the target node; and
a downlink bandwidth between the user equipment and the target node.

Optionally, when the service request sending node, the service response receiving node, or the service node includes a fourth node, the third information includes at least one of the following:
an uplink delay between the fourth node and the target node;
a downlink delay between the fourth node and the target node;
a round trip delay between the fourth node and the target node;
an uplink bandwidth between the fourth node and the target node; and
a downlink bandwidth between the fourth node and the target node, where
the fourth node includes at least one of the following: an IMS, a trusted data network node, a core network function node, or a radio access network node.

Optionally, the computing service implementation apparatus 80 further includes:
a second obtaining module, configured to obtain the third information.

Optionally, the second obtaining module is configured to obtain the third information periodically and/or in an event-triggered manner; or
the second obtaining module is configured to obtain the third information after obtaining the first information.

Optionally, the computing service implementation apparatus 80 further includes:
a first sending module, configured to send information of the target service node to a second node, where the second node is a node that receives a service request data packet sent by the service request sending node.

Optionally, the information of the target service node includes an IP address of the target service node; and the computing service implementation apparatus 80 further includes:
a conversion module, configured to convert a 3GPP-defined identifier of the target service node into an IP address.

Optionally, the computing service implementation apparatus 80 further includes:
a first forwarding module, configured to: when is a node that receives a service request data packet sent by the service request sending node, forward, to the target service node, the service request data packet sent by the service request sending node, and forward, to a service response receiving node, a service response data packet sent by the target service node for the service request data packet.

Optionally, the computing service implementation apparatus 80 further includes:
a second forwarding module, configured to forward, to the target service node based on a mapping relationship, a subsequent data packet that is of a service flow and that is sent by the service request sending node, and forward, to the service response receiving node, a response data packet sent by the target service node for the subsequent data packet of the service flow, where the mapping relationship is a mapping relationship between the service flow of the target service and the target service node.

Optionally, in the mapping relationship,
the service flow of the target service is identified by using the following information: an identifier of the service request sending node, an identifier of the service response receiving node, and a PDU session identifier and a QoS flow identifier corresponding to the target service; or
the service flow of the target service is identified by using the following information: an IP address and/or a port of the service request sending node, and an IP address and/or a port of the service response receiving node; or
the service flow of the target service is identified by using the following information: an IP address and/or a port of the service request sending node, and an IP address and/or a port of the target service node; or
the service flow of the target service is identified by using the following information: a quality of service QoS flow identifier.

Optionally, the first forwarding module is configured to perform one of the following:
if a source IP address in the service request data packet is a private IP address of the service request sending node, setting the source IP address to a public IP address and port number of the service request sending node, and saving a mapping relationship between the private IP address and port number and the public IP address and port number; and
adding public address information, and setting a source IP address of the public address information to an IP address of the first node or an identifier of the first node, and setting a destination IP address of the public address information to an IP address of a UPF node of the target service node, or setting a destination IP address of the public address information to a service instance identifier of the target service node.

The computing service implementation apparatus in this embodiment of this application may be an electronic device, for example, an electronic device with an operating system, or may be a component in an electronic device, for example, an integrated circuit or a chip.

The computing service implementation apparatus provided in this embodiment of this application can implement each process implemented in the method embodiment in FIG. 2, with the same technical effect achieved. To avoid repetition, details are not described herein again.

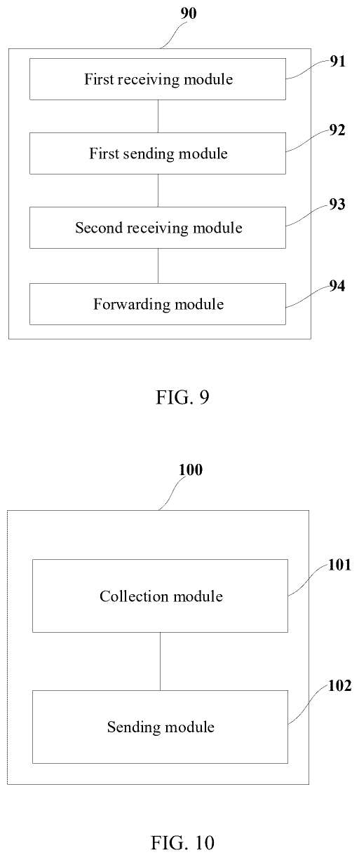

Referring to FIG. 9, an embodiment of this application further provides a computing service implementation apparatus 90, including:
a first receiving module 91, configured to receive a service request data packet sent by a service request sending node, where the service request data packet includes first information, and the first information includes information of a target service requested by the service request sending node;
a first sending module 92, configured to send the first information to a first node, where the first information is used to determine a target service node that provides the target service;
a second receiving module 93, configured to receive information of the target service node sent by the first node; and
a forwarding module 94, configured to forward, to the target service node, the service request data packet sent by the service request sending node, and forward, to a service response receiving node, a service response data packet sent by the target service node for the service request data packet.

In this embodiment of this application, after receiving the service request data packet sent by the service request sending node, the second node itself does not determine the target service node for providing the target service, but requests the first node to determine the target service node for providing the target service, and receives the target service node determined by the first node, so as to forward the data packet between the service request sending node and the target service node, and forward the data packet between the target service node and the service response receiving node.

Optionally, the information of the target service includes a service identifier for identifying the target service.

Optionally, the service identifier is an anycast IP address, a MAC address, or a 3GPP-defined identifier.

Optionally, the first information further includes at least one of the following: an identifier of the service request sending node and an identifier of the service response receiving node.

Optionally, the first information further includes at least one of the following: a computational load metric required by the target service;
a computational delay required by the target service;
a response time required by the target service;
memory information required by the target service;
storage information required by the target service;
a network bandwidth required by the target service; and
a service duration required by the target service.

Optionally, the computing service implementation apparatus 90 further includes:
a forwarding module, configured to forward, to the target service node based on a mapping relationship, a subsequent data packet that is of a service flow and that is sent by the service request sending node, and forward, to the service response receiving node, a response data packet sent by the target service node for the subsequent data packet of the service flow, where the mapping relationship is a mapping relationship between the service flow of the target service and the target service node.

Optionally, in the mapping relationship,
the service flow of the target service is identified by using the following information: an identifier of the service request sending node, an identifier of the service response receiving node, and a protocol data unit PDU session identifier and a QoS flow identifier corresponding to the target service; or
the service flow of the target service is identified by using the following information: an IP address and/or a port of the service request sending node, and an IP address and/or a port of the service response receiving node; or
the service flow of the target service is identified by using the following information: an IP address and/or a port of the service request sending node, and an IP address and/or a port of the target service node; or
the service flow of the target service is identified by using the following information: a QoS flow identifier.

Optionally, the forwarding module is configured to perform one of the following:
if a source IP address in the service request data packet is a private IP address of the service request sending node, setting the source IP address to a public IP address and port number of the service request sending node, and saving a mapping relationship between the private IP address and port number and the public IP address and port number; and
adding public address information, and setting a source IP address of the public address information to an IP address of the second node or an identifier of the second node, and setting a destination IP address of the public address information to an IP address of a UPF node of the target service node, or setting a destination IP address of the public address information to a service instance identifier of the target service node.

The computing service implementation apparatus in this embodiment of this application may be an electronic device, for example, an electronic device with an operating system, or may be a component in an electronic device, for example, an integrated circuit or a chip.

The computing service implementation apparatus provided in this embodiment of this application can implement each process implemented in the method embodiment in FIG. 3, with the same technical effect achieved. To avoid repetition, details are not described herein again.

Referring to FIG. 10, an embodiment of this application further provides a computing service implementation apparatus 100, including:
a collection module 101, configured to collect second information of a service node, where the second information includes at least one of the following: service information and computational load information; and
a sending module 102, configured to send the second information to a first node, so that the second information is used to determine a target service node that provides a target service.

In this embodiment of this application, the third node collects the service information and/or the computational load information of the service node and sends the information to the first node, to assist the first node in determining the target service node that provides the target service.

Optionally, the service information includes at least one of the following:
a service identifier for identifying a service that the service node is capable of providing;
a service instance identifier for identifying the service node;
a service availability time for identifying a time when the service node is capable of providing the service;
a service availability area for representing an area that the service node is capable of serving; and
a network cost to reach the service node.

Optionally, the service identifier and/or the service instance identifier is an IP address, a MAC address, or a 3GPP-defined identifier.

Optionally, the computational load information includes a computational load metric, and the computational load metric is either a numerical value obtained by performing a weighted computation on a plurality of parameters, or a set of parameters.

The computing service implementation apparatus in this embodiment of this application may be an electronic device, for example, an electronic device with an operating system, or may be a component in an electronic device, for example, an integrated circuit or a chip.

The computing service implementation apparatus provided in this embodiment of this application can implement each process implemented in the method embodiment in FIG. 4, with the same technical effect achieved. To avoid repetition, details are not described herein again.

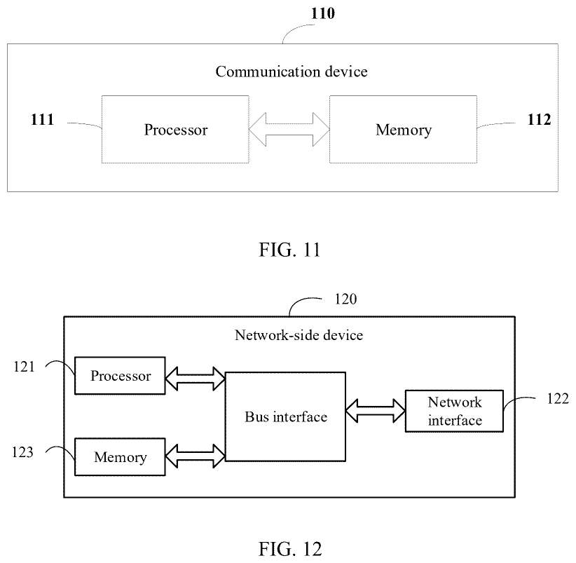

As shown in FIG. 11, an embodiment of this application further provides a communication device 110, including a processor 111 and a memory 112. The memory 112 stores a program or instructions capable of running on the processor 111. When the program or instructions are executed by the processor 111, the steps of the foregoing computing service implementation method embodiment are implemented, with the same technical effect achieved. To avoid repetition, details are not described herein again.

An embodiment of this application further provides a first node, including a processor and a communication interface. The processor is configured to: obtain first information, where the first information includes information of a target service requested by a service request sending node; and determine, based on the first information and second information, a target service node that provides the target service, where the second information includes at least one of the following: service information and computational load information of a service node. The terminal embodiment corresponds to the foregoing method embodiment on the first node side, and each implementation process and implementation of the foregoing method embodiment can be applied to the first node embodiment, with the same technical effect achieved.

An embodiment of this application further provides a second node, including a processor and a communication interface. The communication interface is configured to: receive a service request data packet sent by a service request sending node, where the service request data packet includes first information, and the first information includes information of a target service requested by the service request sending node; send the first information to a first node, where the first information is used to determine a target service node that provides the target service; receive information of the target service node sent by the first node; and forward, to the target service node, the service request data packet sent by the service request sending node, and forward, to a service response receiving node, a service response data packet sent by the target service node for the service request data packet. The terminal embodiment corresponds to the foregoing method embodiment on the second node side, and each implementation process and implementation of the foregoing method embodiment can be applied to the second node embodiment, with the same technical effect achieved.

An embodiment of this application further provides a third node, including a processor and a communication interface. The processor is configured to collect second information of a service node, where the second information includes at least one of the following: service information and computational load information. The communication interface is configured to send the second information to a first node, so that the second information is used to determine a target service node that provides a target service. The terminal embodiment corresponds to the foregoing method embodiment on the third node side, and each implementation process and implementation of the foregoing method embodiment can be applied to the third embodiment, with the same technical effect achieved.

An embodiment of this application further provides a network-side device. As shown in FIG. 12, the network-side device 120 includes a processor 121, a network interface 122, and a memory 123. The network interface 122 is, for example, a common public radio interface (common public radio interface, CPRI).

Specifically, the network-side device 120 in this embodiment of this application further includes a program or instructions stored in the memory 123 and capable of running on the processor 121. When the processor 121 invokes the program or instructions in the memory 123, the method performed by each module shown in FIG. 8, FIG. 9, or FIG. 10 is performed, with the same technical effect achieved. To avoid repetition, details are not described herein again.

An embodiment of this application further provides a readable storage medium. The readable storage medium stores a program or instructions. When the program or instructions are executed by a processor, each process of the foregoing computing service implementation method embodiment is implemented, with the same technical effect achieved. To avoid repetition, details are not described herein again.

The processor is a processor in the terminal in the foregoing embodiment. The readable storage medium includes a computer-readable storage medium, such as a computer read-only memory ROM, a random access memory RAM, a magnetic disk, or an optical disc.

In addition, an embodiment of this application provides a chip. The chip includes a processor and a communication interface. The communication interface is coupled to the processor. The processor is configured to run a program or instructions to implement each process of the foregoing computing service implementation method embodiment, with the same technical effect achieved. To avoid repetition, details are not described herein again.

It should be understood that the chip provided in this embodiment of this application may also be referred to as a system-level chip, a system chip, a chip system, a system-on-chip, or the like.

In addition, an embodiment of this application provides a computer program or program product. The computer program or program product is stored in a storage medium. The computer program or program product is executed by at least one processor to implement each process of the foregoing computing service implementation method embodiment, with the same technical effect achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, and certainly may alternatively be implemented by using hardware. However, in most cases, the former is a more desirable implementation. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. A computing service implementation method, comprising:
obtaining, by a first node, first information, wherein the first information comprises information of a target service requested by a service request sending node; and
determining, by the first node based on the first information and second information, a target service node that provides the target service, wherein the second information comprises at least one of the following: service information and computational load information of a service node.

2. The method according to claim 1, wherein the service node comprises at least one of the following: an Internet Protocol multimedia subsystem (IMS), a trusted data network node, a core network function node, a radio access network node, and a user equipment.

3. The method according to claim 1, wherein the information of the target service comprises a service identifier for identifying the target service,
wherein the service identifier is an Internet Protocol IP address, a media access control (MAC) address, or a 3GPP-defined identifier.

4. The method according to claim 1, wherein the first information further comprises at least one of the following: an identifier of the service request sending node and an identifier of a service response receiving node,
wherein the first information further comprises at least one of the following:
a computational load metric required by the target service;
a computational delay required by the target service;
a response time required by the target service;
memory information required by the target service;
storage information required by the target service;
a network bandwidth required by the target service; and
a service duration required by the target service.

5. The method according to claim 1, wherein the service information of the service node comprises at least one of the following:
a service identifier for identifying a service that the service node is capable of providing;
a service instance identifier for identifying the service node;
a service availability time for identifying a time when the service node is capable of providing the service;
a service availability area for representing an area that the service node is capable of serving; and
a network cost to reach the service node,
wherein at least one of the service identifier or the service instance identifier is an IP address, a MAC address, or a 3GPP-defined identifier.

6. The method according to claim 1, wherein the computational load information comprises a computational load metric, and the computational load metric is either a numerical value obtained by performing a weighted computation on a plurality of parameters, or a set of parameters.

7. The method according to claim 1, wherein the determining, by the first node based on the first information and second information, a target service node that provides the target service comprises:
determining, by the first node based on the first information, the second information, and third information, the target service node that provides the target service, wherein the third information comprises at least one of the following:
at least one of topology information or status information within a mobile network between the service request sending node and a target node;
at least one of topology information or status information within a mobile network between the service node and a target node; and
at least one of topology information or status information within a mobile network between the service response receiving node and a target node, wherein
when the first node is a node that receives a service request sent by the service request sending node, the target node is the first node; or
when a second node is a node that receives a service request sent by the service request sending node, the target node is the second node.

8. The method according to claim 7, wherein when the service request sending node, the service response receiving node, or the service node comprises user equipment, the third information comprises at least one of the following:
a serving base station of the user equipment;
the target node, wherein the target node is a user plane function (UPF) node;
an uplink delay between the user equipment and the serving base station;
a downlink delay between the user equipment and the serving base station;
a round trip delay between the user equipment and the serving base station;
an uplink delay between the serving base station and the target node;
a downlink delay between the serving base station and the target node;
a round trip delay between the serving base station and the target node;
an uplink bandwidth between the user equipment and the serving base station;
a downlink bandwidth between the user equipment and the serving base station;
an uplink bandwidth between the user equipment and the target node; and
a downlink bandwidth between the user equipment and the target node.

9. The method according to claim 7, wherein when the service request sending node, the service response receiving node, or the service node comprises a fourth node, the third information comprises at least one of the following:
an uplink delay between the fourth node and the target node;
a downlink delay between the fourth node and the target node;
a round trip delay between the fourth node and the target node;
an uplink bandwidth between the fourth node and the target node; and
a downlink bandwidth between the fourth node and the target node, wherein
the fourth node comprises at least one of the following: an IMS, a trusted data network node, a core network function node, or a radio access network node.

10. The method according to claim 1, wherein after the determining, by the first node based on the first information and second information, a target service node that provides the target service, the method further comprises:
sending, by the first node, information of the target service node to a second node, wherein the second node is a node that receives a service request data packet sent by the service request sending node,
wherein the information of the target service node comprises an IP address of the target service node; and before the sending, by the first node, information of the target service node to a second node, the method further comprises:
converting, by the first node, a 3GPP-defined identifier of the target service node into an IP address.

11. The method according to claim 1, wherein after the determining, by the first node based on the first information and second information, a target service node that provides the target service, the method further comprises:
when the first node is a node that receives a service request data packet sent by the service request sending node, forwarding, to the target service node, the service request data packet sent by the service request sending node, and forwarding, to a service response receiving node, a service response data packet sent by the target service node for the service request data packet.

12. The method according to claim 11, further comprising:
forwarding, by the first node to the target service node based on a mapping relationship, a subsequent data packet that is of a service flow and that is sent by the service request sending node, and forwarding, to the service response receiving node, a response data packet sent by the target service node for the subsequent data packet of the service flow, wherein the mapping relationship is a mapping relationship between the service flow of the target service and the target service node,
wherein in the mapping relationship,
the service flow of the target service is identified by using the following information: an identifier of the service request sending node, an identifier of the service response receiving node, and a PDU session identifier and a QoS flow identifier corresponding to the target service; or
the service flow of the target service is identified by using the following information: at least one of an IP address or a port of the service request sending node, and at least one of an IP address or a port of the service response receiving node; or
the service flow of the target service is identified by using the following information: at least one of an IP address or a port of the service request sending node, and at least one of an IP address or a port of the target service node; or
the service flow of the target service is identified by using the following information: a quality of service QoS flow identifier.

13. The method according to claim 11, wherein the forwarding, to the target service node, the service request data packet sent by the service request sending node comprises one of the following:
in a case that a source IP address in the service request data packet is a private IP address of the service request sending node, setting, by the first node, the source IP address to a public IP address and port number of the service request sending node, and saving a mapping relationship between the private IP address and port number and the public IP address and port number; and
adding, by the first node, public address information, and setting a source IP address of the public address information to an IP address of the first node or an identifier of the first node, and setting a destination IP address of the public address information to an IP address of a UPF node of the target service node, or setting a destination IP address of the public address information to a service instance identifier of the target service node.

14. A computing service implementation method, comprising:
receiving, by a second node, a service request data packet sent by a service request sending node, wherein the service request data packet comprises first information, and the first information comprises information of a target service requested by the service request sending node;
sending, by the second node, the first information to a first node, wherein the first information is used to determine a target service node that provides the target service;
receiving, by the second node, information of the target service node sent by the first node; and
forwarding, by the second node to the target service node, the service request data packet sent by the service request sending node, and forwarding, to a service response receiving node, a service response data packet sent by the target service node for the service request data packet.

15. The method according to claim 14, wherein the information of the target service comprises a service identifier for identifying the target service,
the service identifier is an anycast IP address, a MAC address, or a 3GPP-defined identifier,
the first information further comprises at least one of the following: an identifier of the service request sending node and an identifier of the service response receiving node,
the first information further comprises at least one of the following:
a computational load metric required by the target service;
a computational delay required by the target service;
a response time required by the target service;
memory information required by the target service;
storage information required by the target service;
a network bandwidth required by the target service; and
a service duration required by the target service.

16. The method according to claim 14, further comprising:
forwarding, by the second node to the target service node based on a mapping relationship, a subsequent data packet that is of a service flow and that is sent by the service request sending node, and forwarding, to the service response receiving node, a response data packet sent by the target service node for the subsequent data packet of the service flow, wherein the mapping relationship is a mapping relationship between the service flow of the target service and the target service node,
wherein in the mapping relationship,
the service flow of the target service is identified by using the following information: an identifier of the service request sending node, an identifier of the service response receiving node, and a protocol data unit (PDU) session identifier and a QoS flow identifier corresponding to the target service; or
the service flow of the target service is identified by using the following information: at least one of an IP address or a port of the service request sending node, and at least one of an IP address or a port of the service response receiving node; or
the service flow of the target service is identified by using the following information: at least one of an IP address or a port of the service request sending node, and at least one of an IP address or a port of the target service node; or
the service flow of the target service is identified by using the following information: a QoS flow identifier.

17. The method according to claim 14, wherein the forwarding, to the target service node, the service request data packet sent by the service request sending node comprises one of the following:
in a case that a source IP address in the service request data packet is a private IP address of the service request sending node, setting, by the second node, the source IP address to a public IP address and port number of the service request sending node, and saving a mapping relationship between the private IP address and port number and the public IP address and port number; and
adding, by the second node, public address information, and setting a source IP address of the public address information to an IP address of the second node or an identifier of the second node, and setting a destination IP address of the public address information to an IP address of a UPF node of the target service node, or setting a destination IP address of the public address information to a service instance identifier of the target service node.

18. A computing service implementation method, comprising:
collecting, by a third node, second information of a service node, wherein the second information comprises at least one of the following: service information and computational load information; and
sending, by the third node, the second information to a first node, so that the second information is used to determine a target service node that provides a target service,
wherein the service information comprises at least one of the following:
a service identifier for identifying a service that the service node is capable of providing;
a service instance identifier for identifying the service node;
a service availability time for identifying a time when the service node is capable of providing the service;
a service availability area for representing an area that the service node is capable of serving; and
a network cost to reach the service node.

19. The method according to claim 18, wherein at least one of the service identifier or the service instance identifier is an IP address, a MAC address, or a 3GPP-defined identifier,
the computational load information comprises a computational load metric, and the computational load metric is either a numerical value obtained by performing a weighted computation on a plurality of parameters, or a set of parameters.

20. A communication device, comprising at least one hardware processor and a memory, wherein the memory stores a program or instructions capable of running on the at least one hardware processor, and the program or instructions, when being executed by the at least one hardware processor, cause the communication device to perform the computing service implementation method according to claim 1.
